(19) United States
(12) Patent Application Publication
(10) Pub. No.: US 2026/0269303 A1
(43) Pub. Date: Sep. 10, 2026

(54) BATTERY ASSEMBLY

(71) Applicants: Hyundai Motor Company, Seoul (KR); Kia Corporation, Seoul (KR)

(72) Inventors: Gyung Hoon Shin, Hwaseong-si (KR); Chan Sol Kim, Hwaseong-si (KR); Kyung Mo Kim, Hwaseong-si (KR)

(21) Appl. No.: 19/541,117

(22) Filed: Feb. 16, 2026

(30) Foreign Application Priority Data
Mar. 6, 2025 (KR) 10-2025-0029254
Sep. 16, 2025 (KR) 10-2025-0132951

(51) Int. Cl. H01M 10/04; H01M 50/204; H01M 50/262

(52) U.S. Cl. CPC H01M 10/0481; H01M 50/204; H01M 50/262

(57) ABSTRACT

A battery assembly may include cell stacks each including a plurality of stacked battery cells, end plates respectively disposed at both ends of each of the cell stacks, a surface pressure-assist member interposed between facing end plates of adjacent ones of the cell stacks, wherein the surface pressure-assist member includes a tool insertion hole configured to allow insertion of a first tool configured to space the surface pressure-assist member and one of the end plates facing the surface pressure-assist member apart from each other.

### CROSS-REFERENCE TO RELATED APPLICATIONS

This application claims priority from Korean Patent Application Nos. 10-2025-0029254 and 10-2025-0132951 respectively filed on Mar. 6, 2025 and Sep. 16, 2025 in the Korean Intellectual Property Office, the disclosures of which are incorporated herein by reference in their entirety.

### TECHNICAL FIELD

The present disclosure relates to technology associated with a battery pack mountable in an electric vehicle or a hybrid vehicle.

### BACKGROUND

An electric vehicle or a hybrid vehicle is equipped with a battery pack so that electric power required to drive the vehicle may be supplied from the battery pack.

The battery pack is configured by accommodating a plurality of battery modules in a battery case, and each battery module is configured to have a structure in which a plurality of battery cells is stacked.

Here, the term "battery assembly" may be understood to refer to a configuration that is accommodated in a battery case to constitute a battery pack, similar to the above-mentioned battery module, but is different from that of a general battery module in conventional cases.

The above matters disclosed in this background section are merely for enhancement of understanding of the general background of the present disclosure and should not be taken as an acknowledgement or any form of suggestion that the matters of this background form the related art already publicly known, available, or in use.

### SUMMARY

Embodiments of the present disclosure may solve the above-mentioned problems and some embodiments of the present disclosure provide a battery assembly capable of easily achieving selective separation and replacement of some cell stacks in units of each cell stack from among a plurality of stacked cell stacks without affecting the remaining cell stacks, achieving an enhancement in stacking density of battery cells, and achieving an overall firm structure.

Advantages of the present disclosure are not limited to the above-described advantages, and other advantages of embodiments of the present disclosure not yet described may be more clearly understood by those skilled in the art from the following detailed description.

In accordance with some embodiments of the present disclosure, the above and other advantages may be accomplished by the provision of a battery assembly that may include: cell stacks, each formed through stacking of a plurality of battery cells; end plates respectively provided at both ends of each of the cell stacks; a surface pressure-assist member interposed between facing end plates of adjacent ones of the cell stacks; and a tool insertion hole provided at the surface pressure-assist member to allow insertion of a first tool configured to space the surface pressure-assist member and one of the end plates facing the surface pressure-assist member apart from each other.

The surface pressure-assist member may include a first plate portion and a second plate portion configured to contact the facing end plates, respectively. A tool-receiving space may be provided between the first plate portion and the second plate portion to communicate with the tool insertion hole to allow insertion of the first tool.

Pressure-actuation holes may be formed at the first plate portion and the second plate portion of the surface pressure-assist member, respectively, to allow pressure applied by the first tool inserted into the tool-receiving space to act on the end plates.

The first plate portion and the second plate portion may be provided with pressure-actuation holes configured to expose the tool-receiving space to the end plates, respectively, and the pressure-actuation hole of the first plate portion and the pressure-actuation hole of the second plate portion may be formed not to overlap each other in a stacking direction of the battery cells in the cell stacks.

The first plate portion and the second plate portion may be provided with pressure-actuation holes configured to expose the tool-receiving space to the end plates, respectively, and the pressure-actuation hole of the first plate portion and the pressure-actuation hole of the second plate portion may be formed to be aligned with the tool insertion hole such that the first tool inserted through the tool insertion hole has common access to the pressure-actuation holes.

The battery assembly may have a mounting surface disposed in parallel to a stacking direction of the battery cells in the cell stacks. The first plate portion and the second plate portion may be provided with pressure-actuation holes configured to expose the tool-receiving space to the end plates, respectively, and the pressure-actuation hole of the first plate portion and the pressure-actuation hole of the second plate portion may be formed to be spaced apart from the mounting surface by different distances, respectively, such that the pressure-actuation holes do not overlap each other.

A minimum distance of the pressure-actuation hole from a fixing surface of a battery case, to which the mounting surface is fixed, may be at least 10% or more of a height of the battery assembly.

Among the two pressure-actuation holes, the pressure-actuation hole disposed farther from the mounting surface may be spaced apart from a fixing surface of a battery case, to which the mounting surface is fixed, by a maximum distance corresponding to 50% or more of a height of the battery assembly.

The first plate portion and the second plate portion may be provided with pressure-actuation holes configured to expose the tool-receiving space to the end plates, respectively, and the end plates may be provided with guide protrusions configured to be inserted into the pressure-actuation holes, respectively.

A pressure guide groove may be formed at the guide protrusion to guide a position of the first tool inserted into the tool-receiving space when the first tool applies pressure.

The guide protrusion of each end plate may be formed such that an outer edge of the guide protrusion is brought into contact with an inner surface of a corresponding one of the pressure-actuation holes when the guide protrusion is inserted into the corresponding pressure-actuation hole, to guide an assembly position of the end plate relative to the surface pressure-assist member.

The battery assembly may have a mounting surface disposed in parallel to a stacking direction of the battery cells in the cell stacks, and the guide protrusion of each end plate may be provided with a guide opening configured to be open toward the mounting surface, to regulate a position of a second tool inserted between the surface pressure-assist member and the end plate.

The cell stacks and the surface pressure-assist member may be stacked in plural, and the tool insertion holes of adjacent ones of the surface pressure-assist members may be arranged in a stacking direction of the battery cells in the cell stacks without overlapping each other.

Adjacent ones of the cell stacks may constitute a single coupling unit, and two surface pressure-assist members disposed at outer edges of the adjacent cell stacks constituting the single coupling unit may be coupled to a clamp extending in the stacking direction of the battery cells of the cell stacks.

The clamp may be aligned with the tool insertion hole of the surface pressure-assist member disposed between the adjacent cell stacks constituting the single coupling unit. The clamp may be provided with a clamp protrusion insertable into the tool insertion hole.

In another embodiment of the present disclosure, a battery pack may include: a battery assembly including cell stacks, each formed through stacking of a plurality of battery cells; end plates respectively provided at both ends of each of the cell stacks; a surface pressure-assist member interposed between facing end plates of adjacent ones of the cell stacks; a tool insertion hole provided at the surface pressure-assist member to allow insertion of a first tool configured to space the surface pressure-assist member and one of the end plates facing the surface pressure-assist member apart from each other; and a clamp coupled to two surface pressure-assist members disposed at outer edges of adjacent ones of the cell stacks constituting a single coupling unit to interconnect the two surface pressure-assist members, and a battery case configured to accommodate the battery assembly in plural.

The battery case may have a fixing surface configured to fix a mounting surface of the battery assembly thereto. A reinforcement member may be provided at the fixing surface to fix the surface pressure-assist member of the battery assembly.

A stud bolt may protrude from the reinforcement member. Mounting flanges may be provided at the surface pressure-assist members symmetrically disposed at opposite sides with respect to the reinforcement member, to protrude toward the stud bolt such that the mounting flanges contact the reinforcement member. A mounting bracket may be provided to encompass the mounting flanges of the surface pressure-assist members. A coupling nut may be provided to be coupled to the stud bolt to press the mounting bracket toward the mounting flanges.

The surface pressure-assist member may include a first plate portion and a second plate portion configured to contact the facing end plates, respectively. A tool-receiving space may be provided between the first plate portion and the second plate portion to communicate with the tool insertion hole to allow insertion of the first tool. The first plate portion and the second plate portion may be provided with pressure-actuation holes configured to expose the tool-receiving space to the end plates, respectively.

The pressure-actuation hole of the first plate portion and the pressure-actuation hole of the second plate portion may be formed to be aligned with the tool insertion hole and not to overlap each other in a stacking direction of the battery cells in the cell stacks such that the first tool inserted through the tool insertion hole has common access to the pressure-actuation holes.

### BRIEF DESCRIPTION OF THE DRAWINGS

The above and other features and other advantages of some example embodiments of the present disclosure may be more clearly understood from the following detailed description taken in conjunction with the accompanying drawings, in which:

FIG. 1 is a perspective view illustrating a battery assembly according to an example embodiment of the present disclosure;

FIG. 2 is a cross-sectional view taken along line F2-F2 in FIG. 1;

FIG. 3 is a view illustrating a surface pressure-assist member of FIG. 1;

FIG. 4 is an enlarged perspective view illustrating an end plate provided at each end of a cell stack of FIG. 1;

FIG. 5 is a cross-section view explaining insertion of a first tool in association with a cross-section in FIG. 2;

FIG. 6 is a cross-section view explaining a procedure in which pressure is applied to the end plate by the first tool from a state of FIG. 5;

FIG. 7 is a cross-section view explaining insertion of a second tool into a gap formed between the surface pressure-assist member and the end plate through action of FIG. 6;

FIG. 8 is a perspective view explaining a state in which the second tool cooperates with the end plate, according to an example embodiment of the present disclosure;

FIG. 9 is a perspective view illustrating engagement of the second tool with a guide opening provided at a guide protrusion of the end plate, according to an example embodiment of the present disclosure;

FIG. 10 is a partially-enlarged view showing a state in which the battery assembly of FIG. 1 is accommodated in plural in a battery case, according to an example embodiment of the present disclosure;

FIG. 11 is a cross-sectional view taken along line F11-F11 in FIG. 10;

FIG. 12 is a perspective view illustrating assembly of battery assemblies in units of each battery assembly, according to an example embodiment of the present disclosure;

FIG. 13 is a perspective view illustrating separation of cell stacks from a battery case in units of each cell stack, according to an example embodiment of the present disclosure;

FIG. 14 is a perspective view illustrating a state of the battery case prepared to enable cell stacks to be assembled into the battery case in units of each cell stack, according to an example embodiment of the present disclosure; and

FIG. 15 is an enlarged perspective view illustrating a structure in which surface pressure-assist members are fixed to a reinforcement member in an area corresponding to area F15 in FIG. 14.

### DETAILED DESCRIPTION OF ILLUSTRATIVE EMBODIMENTS

In the following description of some example embodiments of the present disclosure, a detailed description of known functions and configurations incorporated herein may be omitted when it may obscure the subject matter of the example embodiments of the present disclosure. The example embodiments of the present disclosure may be more clearly understood from the accompanying drawings and the present disclosure should not be necessarily limited by the accompanying drawings. It may be appreciated that changes, equivalents, and substitutes for other embodiments that do not depart from the spirit and technical scopes of the present disclosure may be encompassed in the present disclosure.

It may be understood that, although the terms “first”, “second”, etc. may be used herein to describe various elements, these elements are not necessarily limited by such terms. Such terms may be used merely to distinguish one element from another.

Unless clearly used otherwise, singular expressions may include a plural meaning.

In the present disclosure, the terms "comprising", "including", or the like, are intended to express the existence of the characteristic, the numeral, the step, the operation, the element, the part, or the combination thereof, and do not exclude another characteristic, numeral, step, operation, element, part, or any combination thereof, or any addition thereto.

In an example where an element is "connected" or "linked" to another element, it may be understood that the element may be directly connected or linked to the other element, or another element may be present therebetween. Conversely, in an example where an element is "directly connected" or "directly linked" to another element, it may be understood that no other element is present therebetween.

Any number of components or a variety of components of any one of the configurations disclosed in example embodiments of the present disclosure may be included in other embodiments of the present disclosure. Such components may include any combination of characterized parts disclosed in example embodiments of the present disclosure, and may be arranged to constitute any one of various example configurations disclosed in the present disclosure. Not only structures and arrangements of the components of example embodiments of the present disclosure, but also concepts as to use and operation thereof, may be applied not only to particular example embodiments discussed in the present disclosure, but also to other embodiments of any numbers and in any combinations. In the following description, example embodiments including various characterized parts having various arrangements will be described with reference to the accompanying drawings.

Hereinafter, various example embodiments disclosed in the present disclosure will be described in detail with reference to the accompanying drawings, and same or similar elements may be designated by same reference numerals regardless of the numerals in the drawings and redundant description thereof may be omitted.

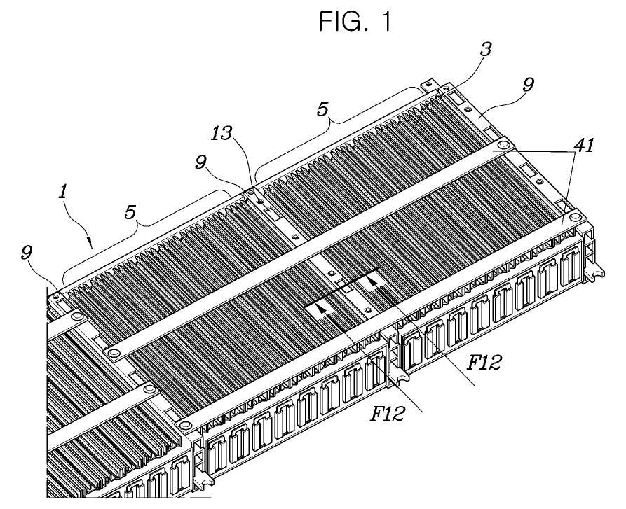

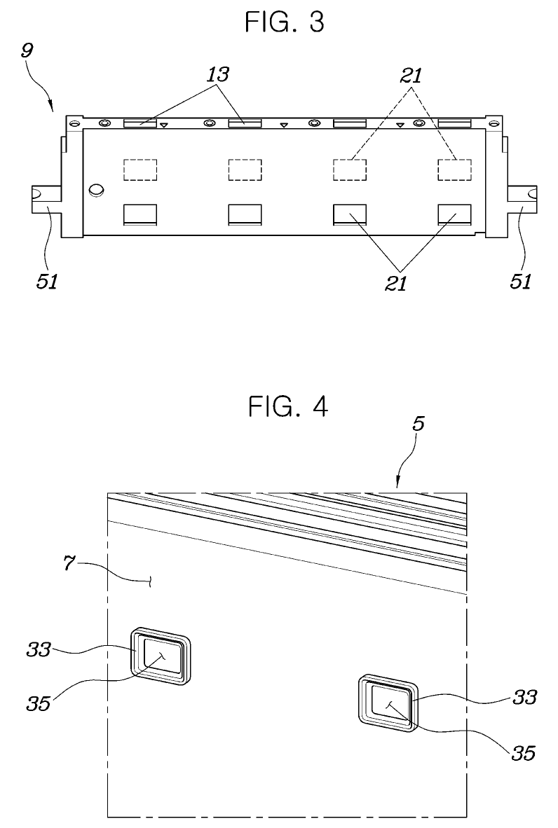

Referring to FIGS. 1-15, a battery assembly 1 of example embodiments of the present disclosure may be configured through inclusion of: cell stacks 5, each of which may be formed through stacking of a plurality of battery cells 3; end plates 7 respectively provided at both ends of each of the cell stacks 5; a surface pressure-assist member 9 interposed between facing end plates 7 of adjacent ones of the cell stacks 5; and a tool insertion hole 13 provided at the surface pressure-assist member 9 to allow insertion of a first tool 11 configured to space the surface pressure-assist member 9 and one of the end plate 7 facing the surface pressure-assist member 9 apart from each other.

That is, as illustrated in FIG. 1, the battery assembly 1 of some embodiments of the present disclosure may be configured through alternate stacking of a plurality of cell stacks 5 and a plurality of surface pressure-assist members 9. In some embodiments, each cell stack 5 may have a configuration in which end plates 7 may be disposed at both ends of the cell stack 5 formed by a plurality of battery cells 3, respectively. The surface pressure-assist members 9 may be pressed against the end plates 7 to provide a surface pressure required or specified for the cell stacks 5. Each surface pressure-assist member 9 may be provided with the tool insertion hole 13 so that, after assembly, the pressed state of the surface pressure-assist member 9 against the end plates 7 may be released when necessary or desired.

For reference, the cell stack 5 may have a configuration in which a plurality of battery cells 3 is linearly stacked to form the cell stack 5, and end plates 7 may be disposed at both ends of the cell stack 5, respectively. Structures such as beads may be omitted from the end plates 7 to maximize the stacking density of battery cells 3, and the surface pressure-assist member 9 may provide stiffness required for the end plates 7 as well as the surface pressure required or specified for the battery cells 3.

Accordingly, in some embodiments, the battery assembly 1 with the above-described configuration may increase the number of stacked battery cells 3, as compared to conventional cases. Ultimately, using some embodiments, it may be possible to obtain an effect of increasing the driving range of a vehicle equipped with the battery assembly 1 as described above.

In some embodiments, the surface pressure-assist member 9 may include a first plate portion 15 and a second plate portion 17 configured to contact the facing end plates 7, respectively, and a tool-receiving space 19 may be provided between the first plate portion 15 and the second plate portion 17 to communicate with the tool insertion hole 13 to allow insertion of the first tool 11.

Although the surface pressure-assist member 9 may have a configuration in which the first plate portion 15 and the second plate portion 17 are manufactured as separate parts to be coupled to each other, as described above, the first plate portion 15 and the second plate portion 17 may be integrally manufactured to constitute the surface pressure-assist member 9 in some embodiments.

In some embodiments, pressure-actuation holes 21 may be formed at the first plate portion 15 and the second plate portion 17 of the surface pressure-assist member 9, respectively, to allow pressure applied by the first tool 11 inserted into the tool-receiving space 19 to act on the end plates 7.

In some embodiments, the first plate portion 15 and the second plate portion 17 may be provided with pressure-actuation holes 21 configured to expose the tool-receiving space 19 to the end plates 7, respectively.

In some embodiments, the first tool 11 may refer to a tool that is inserted through the tool insertion hole 13 of the surface pressure-assist member 9 and functions to apply pressure to the end plates 7 via the pressure-actuation holes 21 such that the end plates 7 are spaced apart from the surface pressure-assist member 9.

In some embodiments, because the perforation direction of the tool insertion hole 13 in the surface pressure-assist member 9 and the perforation direction of each pressure-actuation hole 21 are substantially perpendicular to each other, the first tool 11 may be configured to apply pressure toward the pressure-actuation hole 21 in a direction perpendicular to the direction in which the first tool 11 is inserted through the tool insertion hole 13.

For example, the first tool 11 may include a slider 23 or the like configured to apply pressure to the end plates 7 via the pressure-actuation holes 21. The first tool 11 may be configured to operate the slider 23 by hydraulic pressure supplied from outside, electromagnetic action using electricity, thermal expansion caused by heating, etc., for example.

In some embodiments, the volume of the first tool 11 may be configured to be expanded using a fluid supplied from outside to apply pressure to the end plates 7 through the pressure-actuation holes 21, instead of using the slider 23 described above.

In some embodiments, the pressure-actuation hole 21 of the first plate portion 15 and the pressure-actuation hole 21 of the second plate portion 17 are formed not to overlap each other in the stacking direction of the battery cells 3 in the cell stack 5.

Accordingly, for example in some embodiments, when the first tool 11 applies pressure to one end plate 7 through the pressure-actuation hole 21 formed at the first plate portion 15 of the surface pressure-assist member 9, the pressure applied by the first tool 11 cannot act through the pressure-actuation hole 21 formed at the second plate portion 17. Instead, the second plate portion 17 can function as a structure capable of providing reactive force when pressure is applied through the pressure-actuation hole 21 of the first plate portion 15.

In some embodiments, the structural feature where the pressure-actuation holes 21 of the first plate portion 15 and the second plate portion 17 are disposed not to overlap each other may not only enable selection of application of pressure to the end plate 7 in close contact with the first plate portion 15 or to the end plate 7 in close contact with the second plate portion 17, but may also enable formation of sufficient reactive force when pressure is applied to one end plate 7, to enable the first tool 11 to more smoothly and stably press the end plate 7.

In some embodiments, the pressure-actuation holes 21 of the first plate portion 15 and the second plate portion 17 are formed to be aligned with the tool insertion hole 13 such that the first tool 11 inserted through the tool insertion hole 13 may have common access to both pressure-actuation holes 21.

Accordingly, in some embodiments, it may be possible to easily select whether to apply pressure to the end plate 7 in close contact with the first plate portion 15 or to the end plate 7 in close contact with the second plate portion 17, by adjusting the insertion depth of the first tool 11 through the tool insertion hole 13.

In some embodiments, the battery assembly 1 has a mounting surface 31 disposed in parallel to the stacking direction of the battery cells 3 in the cell stack 5. In some embodiments, the pressure-actuation holes 21 of the first plate portion 15 and the second plate portion 17 may be formed to be spaced apart from the mounting surface 31 by different distances, respectively, such that the pressure-actuation holes 21 do not overlap each other.

In some embodiments, the battery assembly 1 may be accommodated in a battery case 25 to constitute a battery pack 27. In some embodiments, when the surface of the battery assembly 1 facing a fixing surface 29 of the battery case 25, to which the battery assembly 1 is fixed, is referred to as the mounting surface 31, the tool insertion hole 13 may be disposed at the surface of the battery assembly 1 opposite to the mounting surface 31.

Accordingly, in some embodiments, when the distances of the pressure-actuation holes 21 of the first plate portion 15 and the second plate portion 17 from the mounting surface 31 are different, the distances of the pressure-actuation holes 21 of the first plate portion 15 and the second plate portion 17 from the tool insertion hole 13 will also be different. In some embodiments, by adjusting the insertion depth of the first tool 11 through the tool insertion hole 13, accordingly, it may be possible to select which end plate 7 of the two cell stacks 5 respectively disposed at both sides of the surface pressure-assist member 9 will be subjected to pressure.

In some embodiments, the minimum distance of the pressure-actuation hole 21 from the fixing surface 29 of the battery case 25, to which the mounting surface 31 is fixed, may be at least 10% or more of the height of the battery assembly 1.

In some embodiments, a thermal interface material (TIM) may be provided between the mounting surface 31 of the battery assembly 1 and the fixing surface 29 of the battery case 25. In some embodiments, when the pressure-actuation hole 21 is disposed too close to the mounting surface 31 or the fixing surface 29, there may be a possibility that the TIM may overflow into the pressure-actuation hole 21. When such a situation occurs, it may be difficult to subsequently apply pressure to the end plate 7 by the first tool 11 through the pressure-actuation hole 21. Therefore, the above-described condition of the pressure-actuation hole 21 is intended to prevent such a situation in some embodiments.

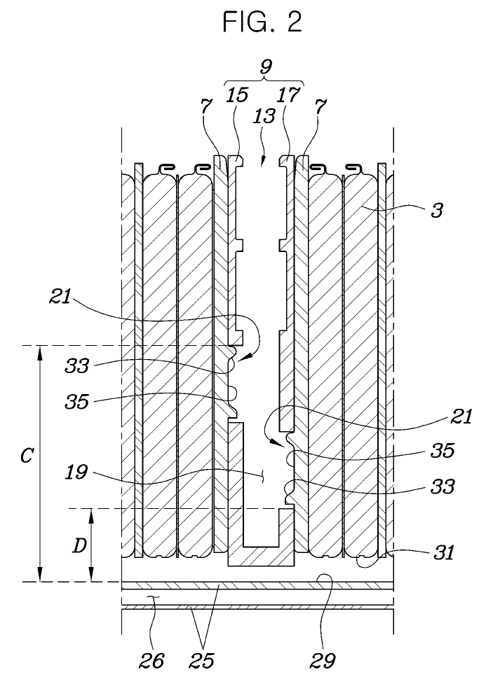

For reference, the height designated by “D” in FIG. 2 illustrates that the minimum distance of the pressure-actuation hole 21 from the fixing surface 29 of the battery case 25 is at least 10% or more of the height of the battery assembly 1 in some embodiments.

For reference, in some embodiments, a cooling channel 26 of the battery case 25 may be provided beneath the fixing surface 29, as illustrated in FIG. 2, enabling cooling by a coolant.

In some embodiments, among the two pressure-actuation holes 21 respectively formed at the first plate portion 15 and the second plate portion 17 of the surface pressure-assist member 9, the pressure-actuation hole 21 disposed farther from the mounting surface 31 may be spaced apart from the fixing surface 29 of the battery case 25 by a maximum distance corresponding to 50% or more of the height of the battery assembly 1. An example maximum distance is designated by “C” in FIG. 2, for example.

In some embodiments, this condition may prevent the first tool 11 from applying pressure to the end plate 7 of the cell stack 5 at a position excessively offset toward the mounting surface 31. Accordingly, it may be possible to prevent the cell stack 5 from being unevenly pressed.

Therefore, in some embodiments, it may also be undesirable that the pressure-actuation hole 21 disposed farther from the mounting surface 31 is spaced apart from the fixing surface 29 by a maximum distance corresponding to 90% or more of the height of the battery assembly 1.

In some embodiments, the end plate 7 may be provided with a guide protrusion 33 configured to be inserted into the pressure-actuation hole 21, as illustrated in FIG. 4 for example.

Accordingly, in some embodiments, during assembly of the battery assembly 1, the assembly position of the cell stack 5 relative to the surface pressure-assist member 9 may be aligned using the pressure-actuation hole 21 and the guide protrusion 33.

Therefore, in some embodiments, the guide protrusion 33 be formed such that an outer edge of the guide protrusion 33 is brought into contact with an inner surface of the pressure-actuation hole 21 when the guide protrusion 33 is inserted into the pressure-actuation hole 21, to guide the assembly position of the end plate 7 relative to the surface pressure-assist member 9.

In some embodiments, at the guide protrusion 33, a pressure guide groove 35 may be formed to guide the position of the first tool 11 inserted into the tool-receiving space 19 when the first tool 11 applies pressure.

Accordingly, in some embodiments, when the first tool 11 applies pressure to the pressure guide groove 35 of the guide protrusion 33 via the pressure-actuation hole 21 using the slider 23 or the like, the pressure guide groove 35 may regulate the position of the slider 23 even if slipping occurs between the slider 23 and the end plate 7. This may ensure that the pressure provided by the first tool 11 acts stably on the end plate 7.

FIGS. 2 and 5-7 illustrate a procedure of forming a gap between the surface pressure-assist member 9 and the end plate 7 using the first tool 11, and then inserting a second tool 37 into the gap to separate the cell stack 5, in accordance with an example method embodiment of the present disclosure.

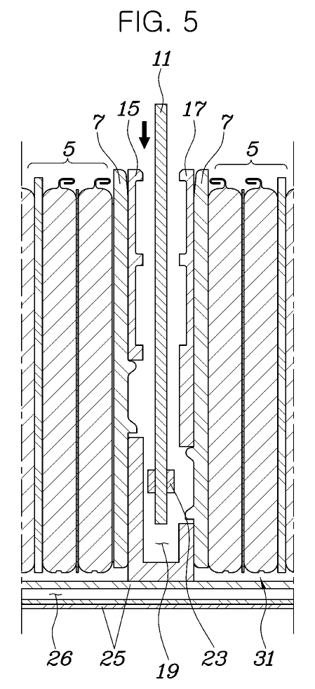

In some embodiments, in a state in which the battery assembly 1 is fixed to the battery case 25, as shown in FIG. 2, the first tool 11 is inserted into the tool-receiving space 19 through the tool insertion hole 13 of the surface pressure-assist member 9, as shown in FIG. 5.

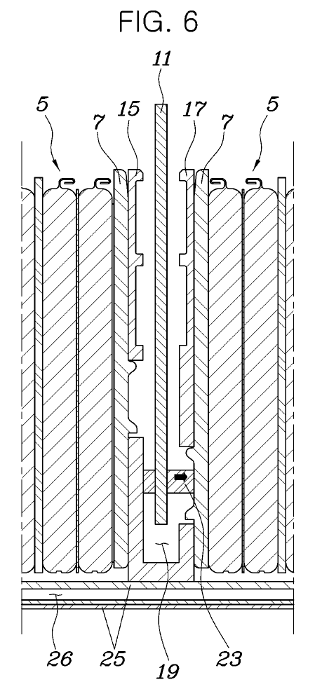

FIG. 6 illustrates a state in which the first tool 11 inserted into the tool insertion hole 13 applies pressure, via the pressure-actuation hole 21, to the end plate 7 of the cell stack 5 disposed at the right side of the surface pressure-assist member 9.

When the pressure applied by the first tool 11 acts on the end plate 7, as shown in FIG. 6, the end plate 7 moves away from the surface pressure-assist member 9, forming a gap allowing insertion of the second tool 37.

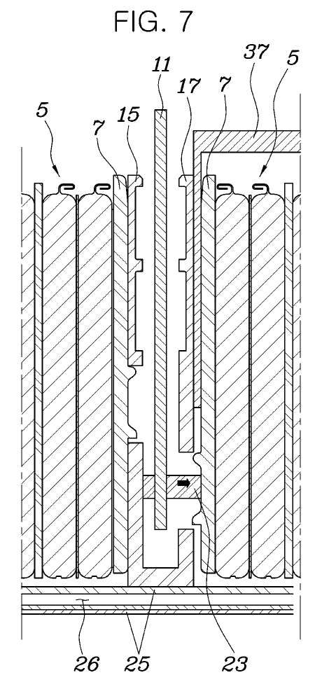

After a second tool 37 is inserted into the gap formed as described above, as shown in FIG. 7, the second tool 37 applies additional pressure to the end plate 7 to further compress the cell stack 5. Accordingly, it may be possible to separate the cell stacks 5 from the battery assembly 1 in units of each cell stack 5 in an upward direction with reference to FIG. 7.

Accordingly, in accordance with some embodiments of the present disclosure, among the plurality of battery assemblies 1 constituting the battery pack 27, individual cell stacks 5 may be selectively separated and replaced. Thus, using an embodiment of the present disclosure, it may be possible to significantly enhance maintenance workability.

That is, when a problem occurs with a specific battery cell 3 and replacement is needed, only the cell stack 5 containing the battery cell 3 may be selectively separated and replaced. Accordingly, it may be possible to greatly enhance maintenance workability, as compared to the case in which the process of separating and replacing the entire battery assembly 1 that contains the problematic cell 3 is required.

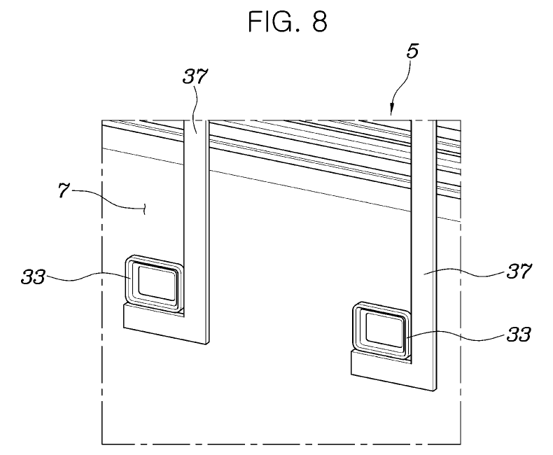

In some embodiments, when the second tool 37 separates the cell stack 5 from the battery assembly 1, as described above, the guide protrusion 33 may be engaged with the second tool 37, as illustrated in FIG. 8, and, as such, may function to prevent the cell stack 5 from slipping downwards from the second tool 37 during upward lifting thereof.

In some embodiments, the guide protrusion 33 of the end plate 7 may be provided with a guide opening 39 configured to be open toward the mounting surface 31, to regulate the position of the second tool 37, which may be inserted between the surface pressure-assist member 9 and the end plate 7.

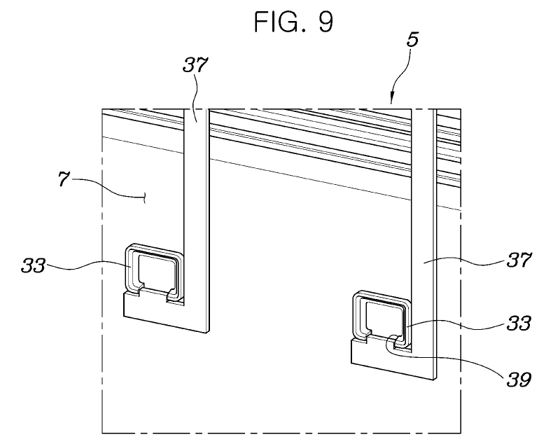

In some embodiments, when the guide protrusion 33 is provided with the guide opening 39, the second tool 37 may move the cell stack 5 in a state in which a part of the second tool 37 is inserted into the guide opening 39, as illustrated in FIG. 9. Accordingly, the position of the second tool 37 relative to the cell stack 5 may be stably secured and maintained.

Accordingly, the second tool 37 may be configured to be inserted through the gap formed between the surface pressure-assist member 9 and the end plate 7, to further press the end plate 7 to move the cell stack 5. The second tool 37 may also be formed to have a shape engageable with the guide protrusion 33 and insertable into the guide opening 39.

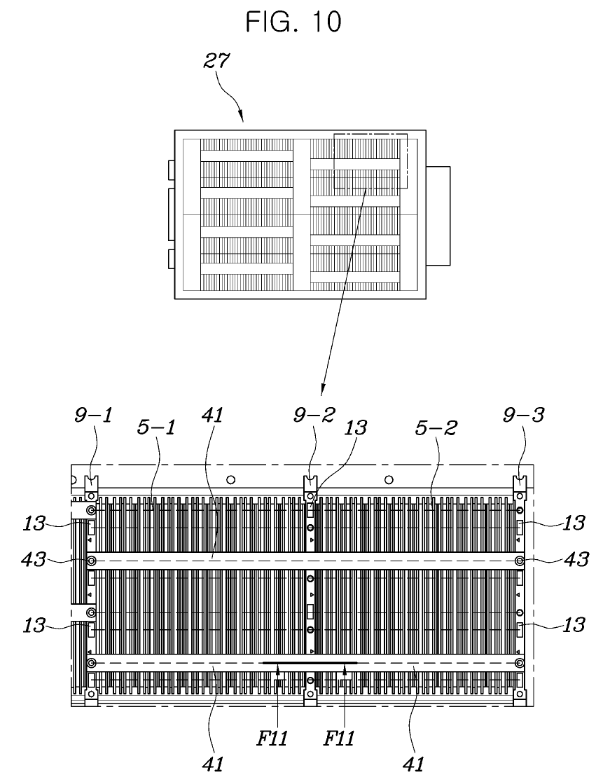

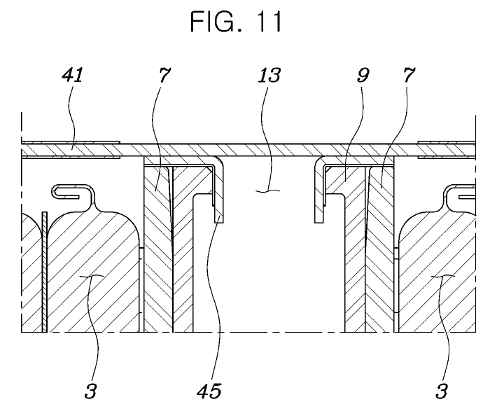

As illustrated in FIG. 10, the battery assembly 1 may be configured through stacking of a plurality of cell stacks 5 and a plurality of surface pressure-assist members 9. The tool insertion holes 13 of adjacent ones of the surface pressure-assist members 9 may be arranged in the stacking direction of the battery cells 3 in the cell stacks 5 without overlapping each other.

In some embodiments, such as in an enlarged portion of FIG. 10, two cell stacks 5 and three surface pressure-assist members 9 are shown. When the left cell stack is referred to as a first cell stack 5-1, the right cell stack as a second cell stack 5-2, and the surface pressure-assist members from left to right as a first surface pressure-assist member 9-1, a second surface pressure-assist member 9-2, and a third surface pressure-assist member 9-3, the tool insertion hole 13 of the second surface pressure-assist member 9-2 may be disposed farther upwards in the drawing than the tool insertion holes 13 of the first and third surface pressure-assist members 9-1 and 9-3 such that the tool insertion holes 13 do not overlap one another in a left-to-right direction on the drawing (the stacking direction of the battery cells in the cell stacks).

In the battery assembly 1 configured as described above, two cell stacks 5 disposed adjacent to each other constitute a single coupling unit, and two surface pressure-assist members 9 disposed at outer edges of the two cell stacks 5 constituting the single coupling unit are coupled to a clamp 41 extending in the stacking direction of the battery cells 3 of the cell stacks 5.

In some embodiments, such as in the above-described example, the first cell stack 5-1 and the second cell stack 5-2 constitute a single coupling unit, and the first surface pressure-assist member 9-1 and the third surface pressure-assist member 9-3 disposed at the outer edges of the two cell stacks 5-1, 5-2 are coupled to each other by the clamp 41. Thus, in some embodiments, the first and second cell stacks 5-1, 5-2 may be coupled to each other.

The clamp 41 may be constituted by a structure such as a metal band or a similar structure. The clamp 41 may be coupled, at both ends thereof, to the first surface pressure-assist member 9-1 and the third surface pressure-assist member 9-3 using hardware such as bolts.

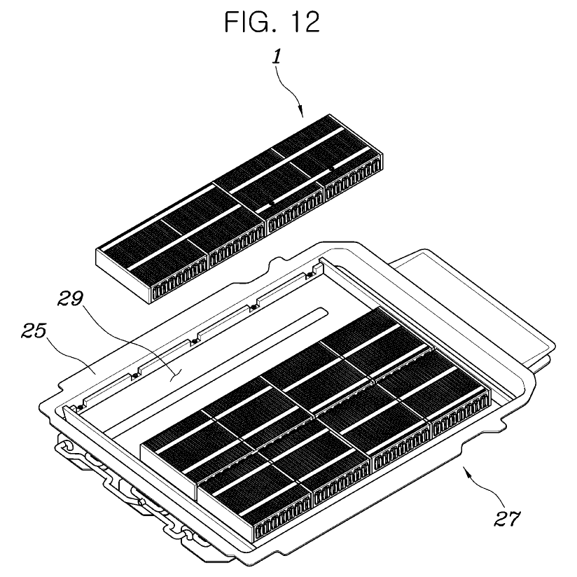

In some embodiments, as illustrated in FIG. 11, the clamp 41 may be aligned with the tool insertion hole 13 of the surface pressure-assist member 9 disposed between the two cell stacks 5 constituting the single coupling unit, and the clamp 41 may be provided with a clamp protrusion 45 insertable into the tool insertion hole 13.

That is, in the above-described example, the tool insertion hole 13 of the second surface pressure-assist member 9-2 disposed between the first cell stack 5 and the second cell stack 5 is aligned with the clamp 41, and the clamp 41 is provided with the clamp protrusion 45. Accordingly, as shown in FIG. 11, the clamp protrusion 45 may be inserted into the tool insertion hole 13 of the second surface pressure-assist member 9-2, constituting a coupled structure.

The above-described configuration allows the clamp 41 to independently secure and maintain the first and second cell stacks 5 in a surface pressure-applied state.

The battery assembly 1 configured as described above may constitute a battery pack 27 as the battery assembly 1 is accommodated and fixed within the battery case 25 configured to accommodate the battery assembly 1.

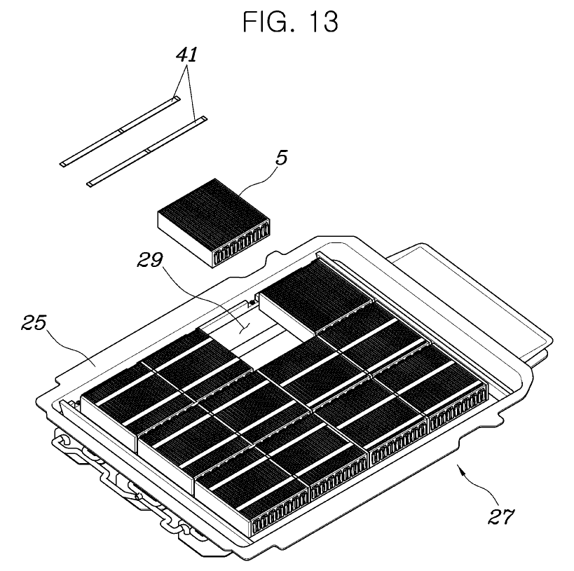

FIG. 12 illustrates a procedure of assembling a battery pack 27 using a battery assembly 1 configured as described above, in accordance with some embodiments of the present disclosure. FIG. 12 illustrates that the battery pack 27 may be assembled into the battery case 25 in units of the battery assembly 1.

This assembly method allows the battery pack 27 to be transported and stored in units of the battery assembly 1.

FIG. 13 illustrates that the battery assembly 1 assembled into the battery case 25 may be separated in units of each cell stack 5.

That is, the clamp 41, which has coupled two cell stacks 5 to each other as a single coupling unit, is first removed. Then, first tools 11 are inserted into respective tool insertion holes 13 of the surface pressure-assist members 9 at both sides of the cell stack 5 to be separated. Subsequently, the first tools 11 press the end plates 7 at both ends of the cell stack 5 through the pressure-actuation holes 21, respectively, to form gaps between respective end plates 7 and respective surface pressure-assist members 9. Second tools 37 are then inserted into respective gaps to further press the end plates 7 at both ends of the cell stack 5. Accordingly, the cell stack 5 may be upwardly separated using the second tools 37.

As described above, in accordance with the present disclosure, it may be possible to highly efficiently perform a maintenance task such as replacement of battery cells 3, through a configuration capable of separating the battery assembly 1 in units of each cell stack 5.

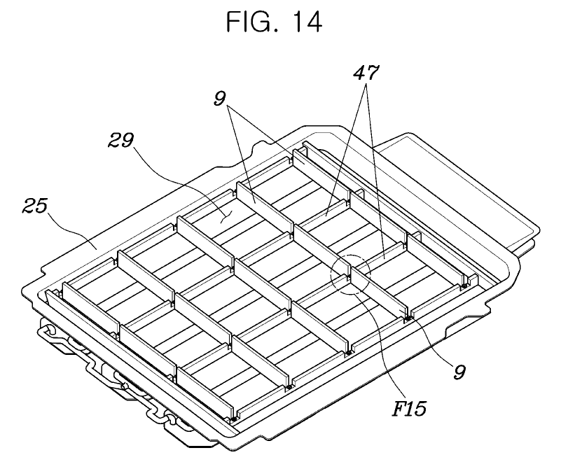

A reinforcement member 47 configured to fix the surface pressure-assist members 9 of the battery assembly 1 may be provided at the fixing surface 29 of the battery case 25, as shown in FIG. 14.

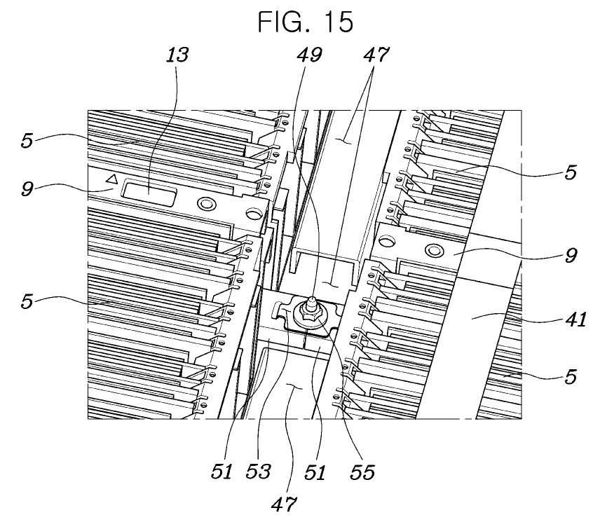

In some embodiments, referring to FIG. 15 along with FIG. 14, a stud bolt 49 protrudes from the reinforcement member 47. Mounting flanges 51 are provided at the surface pressure-assist members 9 symmetrically disposed at opposite sides with respect to the reinforcement member 47, to protrude toward the stud bolt 49 such that the mounting flanges 51 contact the reinforcement member 47. A mounting bracket 53 may be provided to encompass the mounting flanges 51 of the surface pressure-assist members 9. A coupling nut 55 is provided to be coupled to the stud bolt 49 to press the mounting bracket 53 toward the mounting flanges 51.

In some embodiments, when the mounting flanges 51 of the surface pressure-assist members 9 are symmetrically disposed at opposite sides of the reinforcement member 47 with respect to the stud bolt 49 of the battery case 25, and are then fixed by the mounting bracket 53 and the coupling nut 55, the surface pressure-assist members 9 may be securely assembled to the battery case 25.

In the above-described state, it may be possible to insert one cell stack 5 between two surface pressure-assist members 9 after pressing the cell stacks 5 using the second tools 37 in accordance with an order reverse to separation of each cell stack 5. Thereafter, gaps for removing the second tools 37 are maintained using the first tools 11. In this state, the second tools 37 and the first tools 11 are sequentially removed. Finally, the clamp 41 is then fastened. Through this process, the battery pack 27 may be assembled into the battery case 25 in units of each cell stack 5, as shown in FIG. 13, without being assembled in units of each battery assembly 1, as shown in FIG. 12. Accordingly, it may be possible to not only enable all cell stacks 5 of the battery pack 27 to be tightly and firmly assembled within the battery case 25, but also to configure the battery pack 27 to be separable in units of each cell stack 5.

As apparent from the above description, some embodiments of the present disclosure may enable selective separation and replacement of some cell stacks in units of each cell stack, from among a plurality of stacked cell stacks, without affecting other cell stacks, may enhance the stacking density of battery cells, and may realize a robust structure of the battery assembly.

Effects and advantages attainable through some embodiments of the present disclosure are not necessarily limited to the above-described effects and advantages, and other effects and advantages of the present disclosure not described herein may be more clearly understood by those skilled in the art from the above description.

Although some example embodiments of the present disclosure have been disclosed for illustrative purposes, those skilled in the art will appreciate that various modifications, additions, combinations, and substitutions are possible for other embodiments, without departing from the scopes and spirit of the disclosure as disclosed in the accompanying claims and equivalents thereof.

What is claimed is:

1. A battery assembly comprising:
cell stacks, wherein each cell stack includes a plurality of stacked battery cells;
end plates respectively disposed at both ends of each of the cell stacks;
a surface pressure-assist member interposed between facing end plates of adjacent ones of the cell stacks, wherein the surface pressure-assist member includes a tool insertion hole configured to allow insertion of a first tool configured to space the surface pressure-assist member and one of the end plates facing the surface pressure-assist member apart from each other.

2. The battery assembly according to claim 1, wherein:
the surface pressure-assist member comprises a first plate portion and a second plate portion configured to contact the facing end plates, respectively; and
a tool-receiving space is between the first plate portion and the second plate portion that communicates with the tool insertion hole and that is configured to allow insertion of the first tool.

3. The battery assembly according to claim 2, wherein each of the first plate portion and the second plate portion of the surface pressure-assist member, respectively, includes pressure-actuation holes configured to allow pressure applied by the first tool inserted into the tool-receiving space to act on the end plates via the pressure-actuation holes.

4. The battery assembly according to claim 2, wherein each of the first plate portion and the second plate portion includes pressure-actuation holes configured to expose the tool-receiving space to the end plates, respectively; and
wherein a first pressure-actuation hole of the pressure-actuation holes in the first plate portion and a second pressure-actuation hole of the pressure-actuation holes in the second plate portion are disposed to not to overlap each other in a stacking direction of the stacked battery cells in the cell stacks.

5. The battery assembly according to claim 2, wherein:
the first plate portion and the second plate portion include pressure-actuation holes configured to expose the tool-receiving space to the end plates, respectively; and
a first pressure-actuation hole of the pressure-actuation holes in the first plate portion and a second pressure-actuation hole of the pressure-actuation holes in the second plate portion are disposed to be aligned with the tool insertion hole and configured such that the first tool inserted through the tool insertion hole has common access to the first pressure-actuation hole and the second pressure-actuation hole.

6. The battery assembly according to claim 2, wherein:
the battery assembly includes a mounting surface disposed in parallel to a stacking direction of the stacked battery cells in the cell stacks;
the first plate portion and the second plate portion include pressure-actuation holes configured to expose the tool-receiving space to the end plates, respectively; and
a first pressure-actuation hole of the pressure-actuation holes in the first plate portion and a second pressure-actuation hole of the pressure-actuation holes in the second plate portion are disposed to be spaced apart from the mounting surface by different distances, respectively, such that the first pressure-actuation hole and the second pressure-actuation hole do not overlap each other in a first direction perpendicular to the stacking direction of the stacked battery cells in the cell stacks.

7. The battery assembly according to claim 6, wherein a minimum distance of any of the pressure-actuation holes from a fixing surface of a battery case, to which the mounting surface is fixed, is at least 10% or more of a height of the battery assembly.

8. The battery assembly according to claim 6, wherein, among the first pressure-actuation hole and the second pressure-actuation hole, one being disposed farther from the mounting surface is spaced apart from a fixing surface of a battery case, to which the mounting surface is fixed, by a maximum distance corresponding to 50% or more of a height of the battery assembly.

9. The battery assembly according to claim 2, wherein:
the first plate portion and the second plate portion include pressure-actuation holes configured to expose the tool-receiving space to the end plates, respectively; and
the end plates include guide protrusions configured to be inserted into the pressure-actuation holes, respectively.

10. The battery assembly according to claim 9, wherein at least some of the guide protrusions include a pressure guide groove configured to guide a position of the first tool inserted into the tool-receiving space based on the first tool applying pressure to one of the end plates.

11. The battery assembly according to claim 9, wherein each of the guide protrusions of the end plates includes an outer edge configured to be in contact with an inner surface of a corresponding one of the pressure-actuation holes based on the corresponding guide protrusion being inserted into the corresponding pressure-actuation hole, to guide an assembly position of the corresponding end plate relative to the surface pressure-assist member.

12. The battery assembly according to claim 9, wherein:
the battery assembly includes a mounting surface disposed in parallel to a stacking direction of the stacked battery cells in the cell stacks; and
at least some of the guide protrusions of the end plates include a guide opening configured to be open toward the mounting surface and configured to regulate a position of a second tool inserted between the surface pressure-assist member and the corresponding end plate.

13. The battery assembly according to claim 2, wherein:
the cell stacks and the surface pressure-assist member are stacked in plural; and
the tool insertion holes of adjacent ones of the surface pressure-assist members are arranged in a stacking direction of the stacked battery cells in the cell stacks without overlapping each other.

14. The battery assembly according to claim 13, wherein:
adjacent ones of the cell stacks constitute a single coupling unit; and
two surface pressure-assist members disposed at outer edges of the adjacent cell stacks constituting the single coupling unit are coupled to a clamp extending in the stacking direction of the stacked battery cells of the cell stacks.

15. The battery assembly according to claim 14, wherein:
the clamp is aligned with the tool insertion hole of the surface pressure-assist member disposed between the adjacent cell stacks constituting the single coupling unit; and
the clamp includes a clamp protrusion insertable into the tool insertion hole.

16. A battery pack comprising:
a battery assembly comprising:
a first group of cell stacks, wherein each of the cell stacks includes a plurality of stacked battery cells,
end plates respectively disposed at both ends of each of the cell stacks,
surface pressure-assist members comprising two outer surface pressure-assist members and an interposing surface pressure-assist member,
wherein the two outer surface pressure-assist members are disposed at outer end plates of the end plates corresponding to outer edges of the first group of cell stacks,
wherein the interposing surface pressure-assist member is disposed between the two outer surface pressure-assist members,
wherein the interposing surface pressure-assist member is interposed between facing end plates of adjacent ones of the cell stacks of the first group of cell stacks,
wherein each of the surface pressure-assist members includes a tool insertion hole configured to allow insertion of a first tool configured to space a selected one surface pressure-assist member of the surface pressure-assist members and a respective one of the end plates facing the selected one surface pressure-assist member apart from each other, and
a clamp coupled to the two outer surface pressure-assist members to interconnect the two outer surface pressure-assist members; and
a battery case configured to accommodate the battery assembly in plural.

17. The battery pack according to claim 16, wherein the battery assembly comprises a mounting surface; and
wherein the battery case comprises:
a fixing surface configured to fix the mounting surface of the battery assembly to the fixing surface, and
a reinforcement member disposed at the fixing surface and configured to fix the surface pressure-assist member of the battery assembly to the fixing surface.

18. The battery pack according to claim 17, further comprising:
a stud bolt protruding from the reinforcement member;
mounting flanges extending from the surface pressure-assist members symmetrically disposed at opposite sides with respect to the reinforcement member, configured to protrude toward the stud bolt such that the mounting flanges contact the reinforcement member;
a mounting bracket engaging the mounting flanges of the surface pressure-assist members; and
a coupling nut coupled to the stud bolt to engage the mounting bracket toward the mounting flanges.

19. The battery pack according to claim 16, wherein the interposing surface pressure-assist member comprises:
a first plate portion and a second plate portion configured to contact the facing end plates, respectively; and
a tool-receiving space between the first plate portion and the second plate portion to communicate with the tool insertion hole and configured to allow insertion of the first tool; and
wherein the first plate portion and the second plate portion include pressure-actuation holes configured to expose the tool-receiving space to the facing end plates, respectively.

20. The battery pack according to claim 19, wherein a first pressure-actuation hole of the pressure-actuation holes in the first plate portion and a second pressure-actuation hole of the pressure-actuation holes in the second plate portion are aligned with the tool insertion hole and are not overlapping with each other in a first direction perpendicular to a stacking direction of the stacked battery cells in the cell stacks such that the first tool inserted through the tool insertion hole has common access to the first pressure-actuation hole and the second pressure-actuation hole.
